(19) United States
(12) Patent Application Publication
(10) Pub. No.: US 2026/0063265 A1
(43) Pub. Date: Mar. 5, 2026

(54) METHOD FOR PRODUCING A PLURALITY OF PROJECTION OPTICS FOR A PLURALITY OF HEADLIGHTS FOR MOTOR VEHICLES

(71) Applicant: Hella GmbH & Co. KGaA, Lippstadt (DE)

(72) Inventors: Björn Dreßler, Menden (DE); Bernd Fischer, Altenbeken (DE); Daniela Karthaus, Lippstadt (DE); Rainer Kauschke, Lippstadt (DE); Dirk Kliebisch, Paderborn (DE); Frank Paßgang, Lippstadt (DE); Peter Rausch, Münster (DE); Martin Seipel, Bad Wünnenberg (DE); Dirk Sossenheimer, Lippstadt (DE); Jörg Sudahl, Lippstadt (DE)

(21) Appl. No.: 19/313,700

(22) Filed: Aug. 28, 2025

(30) Foreign Application Priority Data
Sep. 5, 2024 (DE) 102024125403.3

(51) Int. Cl. F21S 41/20; F21S 41/25

(52) U.S. Cl. CPC F21S 41/285; F21S 41/25

(57) ABSTRACT

A method is provided for producing numerous projection lenses for numerous headlamps for motor vehicles. Each projection lens is configured to convert an expanded light distribution generated by a primary lens in the headlamp into a light distribution corresponding to the initial light distribution obtained with the headlamp. Each projection lens comprises a Fresnel lens. Numerous identical Fresnel lenses are produced forming the initial Fresnel lenses. The size and/or shape of one of these initial Fresnel lenses is altered to obtain a first Fresnel lens that can be incorporated in a first headlamp. The size and/or shape of a second initial Fresnel lens is altered to obtain a second Fresnel lens that can be incorporated in a second headlamp that has a different size and/or shape than the first Fresnel lens.

### CROSS REFERENCE

This application claims priority to European Application No. 10 2024 125403.3, filed Sep. 5, 2024, the entirety of which is hereby incorporated by reference.

### FIELD OF THE INVENTION

The present invention relates to a method for producing numerous projection lenses for numerous headlamps for motor vehicles. The present invention also relates to a projection lens produced with this method, a headlamp that has such a projection lens, as well as numerous projection lenses produced with this method, and numerous headlamps with these projection lenses.

### BRIEF SUMMARY OF THE INVENTION

This type of method and projection lens are disclosed in DE 11 2013 007 443 B4. The projection lens described therein is configured to convert an expanded light distribution generated by a primary lens in the headlamp into a light distribution corresponding to the initial light distribution obtained with the headlamp. The projection lens can have at least one substrate made of a transparent material, which has a Fresnel structure with numerous coaxial circular steps.

Projection lenses made of glass or plastic are frequently used for modern headlamp modules, in particular the main headlamp modules. Because the number of different modules differs with different headlamps, numerous projection lenses with different external shapes must be produced. By way of example, when producing projection lenses through injection molding, a separate tool must be used for each projection lens, which is associated with high costs.

### BRIEF SUMMARY OF THE INVENTION

The fundamental problem addressed by the present invention is to create a method with which projection lenses of different external shapes can be produced less expensively. Furthermore, a projection lens produced with this method, a headlamp with this type of projection lens, numerous projection lenses produced with this method, and numerous headlamps with these projection lenses are to be created.

In an example embodiment, the method is characterized by the following steps: numerous identical Fresnel lenses are produced forming the initial Fresnel lenses; the size and/or shape of one of these initial Fresnel lenses is altered to obtain a first Fresnel lens that can be incorporated in a first headlamp; the size and/or shape of a second initial Fresnel lens is altered to obtain a second Fresnel lens that can be incorporated in a second headlamp that has a different size and/or shape than the first Fresnel lens.

Consequently, the first headlamp can be different than the second headlamp with regard to the size and/or shape of the Fresnel lens forming the projection lens. By producing an initial Fresnel lens, which is then tailored to a specific module in a subsequent step by changing its size and/or shape, the costs for the tools necessary for the production of the Fresnel lens can be significantly reduced. By way of example, an initial Fresnel lens can be produced that is substantially larger than the Fresnel lenses that are to be produced with the method. Furthermore, the external shape of the Fresnel lenses can be tailored to the headlamp module much quicker with the method obtained with the invention than in the prior art.

More than two Fresnel lenses can be produced that are of different sizes and/or shapes.

The size and/or shape of the initial Fresnel lens can be altered by cutting. The size and/or shape of the initial Fresnel lens can also be altered with a laser beam. The size and/or shape of the initial Fresnel lens can also be altered in a stamping process. All of these approaches are inexpensive. They can be selected on the basis of the extent to which the size and shape are to be altered.

Numerous initial Fresnel lenses can be produced with different focal lengths. Consequently, these Fresnel lenses can be used for different types of headlamps modules.

The initial Fresnel lenses can be produced through injection molding. This requires only one injection molding tool for the initial Fresnel lens.

The initial Fresnel lens can be a film. The Fresnel lens obtained with this film can then be applied to a transparent substrate in a subsequent step.

Numerous initial Fresnel lenses can also be formed on the film. These initial Fresnel lenses can have different focal lengths, which can then be used for different types of headlamp modules.

The projection lens may be produced with the method obtained with the invention.

The projection lens may be a projection lens obtained with the invention.

The numerous projection lenses may be produced with the method obtained with the invention.

The projection lenses may be projection lenses obtained with the invention.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows an initial Fresnel lens produced by an example method.

FIG. 2 shows a first embodiment of an example Fresnel lens.

FIG. 3 shows a second embodiment of an example Fresnel lens.

FIG. 4 shows a third embodiment of an example Fresnel lens produced.

### DETAILED DESCRIPTION OF THE INVENTION

Identical and functionally identical parts have the same reference symbols in the drawings.

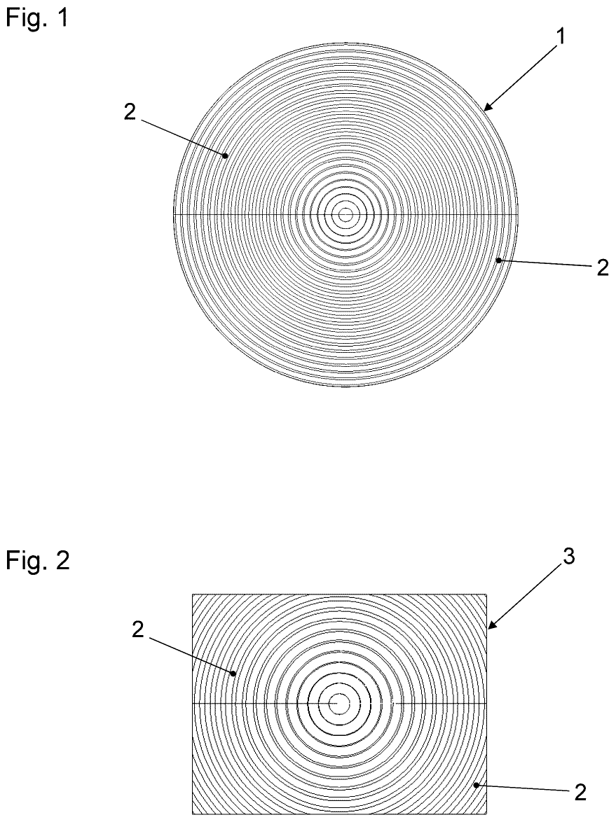

Numerous identical Fresnel lens are produced with the method obtained with the invention, forming the initial Fresnel lenses 1 (see FIG. 1). The exemplary embodiment of the initial Fresnel lens 1 shown in FIG. 1 has a circular cross section. This Fresnel lens 1 has numerous circular steps 2 forming the Fresnel structure, which are coaxial to the circular cross section of the initial Fresnel lens 1.

The initial Fresnel lens 1 can be produced through injection molding. It can also be a film.

Different Fresnel lenses 3, 4, 5 are produced from the initial Fresnel lens 1 in subsequent steps of the method, which can then be incorporated in different headlamps.

To obtain the Fresnel lenses 3, 4, and 5 shown in FIGS. 2 to 4, the shapes and sizes of initial Fresnel lenses 1 are altered. It is possible to change just the shape of the lens, without altering its size in at least one direction. It is also possible to change just the size of the Fresnel lens 1 in at least one direction, without altering its shape.

The size of the initial Fresnel lens 1 is altered in two directions, which are perpendicular to one another to obtain the first Fresnel lens 3 shown in FIG. 2. Furthermore, the circular shape of the initial Fresnel lens 1 is converted to a square.

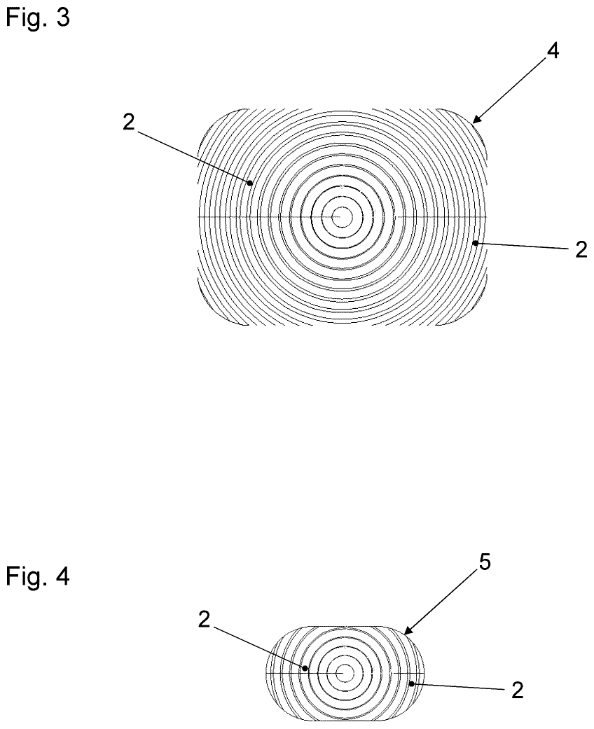

The size of the initial Fresnel lens 1 is altered in two directions, which are perpendicular to one another to obtain the second Fresnel lens 4 shown in FIG. 3. Furthermore, the circular shape of the initial Fresnel lens 1 is converted to a square with rounded corners.

The size of the initial Fresnel lens 1 is significantly altered in two directions, which are perpendicular to one another, to obtain the third Fresnel lens 5 shown in FIG. 4. Furthermore, the circular shape of the initial Fresnel lens 1 is converted to an oval.

The size and/or shape of the initial Fresnel lens 1 can be altered by cutting, and/or with a laser beam, and/or by stamping.

### LIST OF REFERENCE SYMBOLS

1 initial Fresnel lens
2 circular steps forming the Fresnel structure
3 first Fresnel lens
4 second Fresnel lens
5 third Fresnel lens

1. A method for producing numerous projection lenses for numerous headlamps for motor vehicles, wherein each projection lens is configured to convert an expanded light distribution generated by a primary lens in the headlamp into a light distribution corresponding to the initial light distribution obtained with the headlamp, wherein each projection lens comprises a Fresnel lens, the method comprising the steps of:
producing numerous identical initial Fresnel lenses;
altering a size and/or shape of one of the initial Fresnel lenses to obtain a first Fresnel lens that is incorporated in a first headlamp; and
altering a size and/or shape of another of the initial Fresnel lenses to obtain a second Fresnel lens that is incorporated in a second headlamp that has a different size and/or shape than the first Fresnel lens.

2. The method according to claim 1, wherein the first headlamp differs from the second headlamp at least with regard to the size and/or shape of the first Fresnel lens as compared to the second Fresnel lens, each of which form the projection lens of their respective headlamps.

3. The method according to claim 1, wherein more the first Fresnel lens and the second Fresnel lens are produced that are of different sizes and/or shapes.

4. The method according to claim 1, wherein the size and/or shape of the initial Fresnel lenses is altered by cutting to obtain the first Fresnel lens and second Fresnel lens.

5. The method according to claim 1, wherein the size and/or shape of the initial Fresnel lenses is altered with a laser beam to obtain the first Fresnel lens and the second Fresnel lens.

6. The method according to claim 1, wherein the size and/or shape of the initial Fresnel lenses is altered by stamping to obtain the first Fresnel lens and the second Fresnel lens.

7. The method according to claim 1, wherein numerous initial Fresnel lenses are produced with different focal lengths.

8. The method according to claim 1, wherein the initial Fresnel lenses are injection molded.

9. The method according to claim 1, wherein the initial Fresnel lenses are a film.

10. The method according to claim 9, wherein the first Fresnel lens and the second Fresnel lens obtained by altering the sizes and/or shapes of the initial Fresnel lenses in the form of a film are applied to a transparent substrate in a subsequent step.

11. The method according to claim 9, wherein numerous initial Fresnel lenses are formed on the film.

12. A projection lens for a headlamp in a motor vehicle, the projection lens being configured to convert an expanded light distribution generated by a primary lens in the headlamp into a light distribution corresponding to the initial light distribution obtained with the headlamp, the projection lens comprising:
a Fresnel lens produced with the method according to claim 1.

13. A headlamp for a motor vehicle, the headlamp comprising:
at least one light source;
a primary lens configured to focus light from the at least one light source such that an expanded light distribution is obtained;
a projection lens configured to convert the expanded light distribution generated by the primary lens into a light distribution corresponding to the initial light distribution obtained with the headlamp;
wherein the projection lens is a projection lens according to claim 12.

14. Numerous projection lenses for numerous headlamps for motor vehicles, each projection lens being configured to convert an expanded light distribution generated by the primary lens in the headlamp into a light distribution corresponding to the initial light distribution obtained with the headlamp, each of the projection lenses comprising:
a Fresnel lens (3, 4, 5), wherein the numerous projection lenses are produced with the method according to claim 1.

15. Numerous headlamps for motor vehicles, each headlamp comprising:
at least one light source;
a primary lens configured to focus light from the at least one light source such that an expanded light distribution is obtained;
a projection lens configured to convert the expanded light distribution generated by the primary lens into a light distribution corresponding to the initial light distribution obtained with the headlamp,
wherein the projection lenses for the numerous headlamps are projection lenses according to claim 14.
